(19) United States
(12) Patent Application Publication
(10) Pub. No.: US 2003/0158365 A1
(43) Pub. Date: Aug. 21, 2003

(54) Continuous production of thermoplastic polyurethane elastomers

(76) Inventors: Wolfgang Brauer, Leverkusen (DE); Herbert Heidingsfeld, Frechen (DE); Hans-Georg Hoppe, Leichlingen (DE); Wolfgang Kaufhold, Koln (DE); Bernhard Schulte, Krefeld (DE); Jack C. Chan, Mission Viejo, CA (US); Steven C. Manning, Imperial, PA (US); Nicholas R. Nardo, Weirton, WV (US)

Correspondence Address: BAYER POLYMERS LLC, 100 BAYER ROAD, PITTSBURGH, PA, 15205, US

(21) Appl. No.: 10/043,738

(22) Filed: Jan. 9, 2002

(51) Int. Cl. C08G 18/00

(52) U.S. Cl. 528/44

(57) ABSTRACT

A continuous process for the preparation of a thermoplastic polyurethane elastomer is disclosed. The process is carried out at 130 to 250° C. and comprises reacting at least one polyether diol with at least one organic diisocyanate and 1,4-di-(2,2′-hydroxyethyl)-hydroquinone, in the presence of tin dioctoate as a catalyst. The resulting thermoplastic polyurethane has a glass transition temperature (T_{g}) below 50° C. The inventive thermoplastic polyurethane is suitable for making injection molded or extruded articles.

This invention relates to a continuous, catalyzed process for producing thermoplastically processable polyurethane elastomers (TPU) with an aromatic chain extender. More particularly, the inventive TPU exhibits a glass transition temperature (T_{g}) below 50° C.

The applications for thermoplastic polyurethanes (TPU's) are broad because they display good elastomeric characteristics and they are able to be easily further processed thermoplastically. An overview of TPU, its characteristics and its uses is given, for example, in Plastic Materials 68(1978)819, in Rubber, Caoutchouc and Plastics 35(1982)569 and in the Plastic Materials Handbook by G. Becker, D. Braun, Volume 7 “Polyurethanes” Munich, Vienna, Carl Hanser Publishing House 1983. An overview of the production process is provided by Plastic Moulders 40(1989).

For the most part TPU's are built up from linear polyols such as polyester polyols and polyether polyols, organic diisocyanates and short chain alcohols, preferably difunctional alcohols, as chain extenders. Such TPU's may be produced either batch-wise or continuously.

As a rule the chain extenders are short chain diols, mostly aliphatic diols including such as, ethylene glycol, butane diol and hexane diol. Thermoplastic polyurethanes with the rarely used aromatic chain extensions, such as, for example, the hydroxyalkylene ether of hydroquinone, distinguish themselves by having particularly high thermal stability, very high elasticity and low compression set.

A soft thermoplastically processable elastomer that is particularly suitable for the manufacture of soft, non-blocking films is disclosed in EP-A- 0 308 683. It is produced from a mixed polyester (molecular weight of 1800 to 3600) an organic diisocyanate and an aromatic glycol chain extender. This TPU is produced, preferably in a single step process, in a reactor at a starting temperature of 110 to 140° C. using stannous (tin) octoate or tin dilaurate as catalysts within a time period of a few minutes.

Hard TPU's having glass transition temperatures of at least 50° C., based on special aromatic chain extenders are disclosed in U.S Pat. No. 5,574,092. For manufacturing, a one step batch process is used with a starting temperature of 80 to 100° C. with the use of 0.02 to 2 percent weight of catalyst, such as organic tin compounds. A contact time is not disclosed. The prepared TPU is poured onto sheets and cooled.

Both of the methods described above are not suitable for the economic production of TPU because of their long contact times and/or their costly handling.

The continuous process for making TPU at high temperatures in a combination of two reactors has been disclosed in U.S. Pat. No. 5,795,948. This process permits the economic manufacture of TPU. The procedure entails a multi-step process, wherein the first step a polyol is mixed with a diisocyanate. In the second step an isocyanate-terminated prepolymer is produced in a reactor at a temperature greater than 100° C. In a third step the prepolymer is mixed with a chain extending diol having a molecular weight of 62 to 500. In a fourth step the reaction is completed in a second reactor with high shearing action. Polyester is used in the examples as polyol and butane diol as the chain extender. In particular, stirred tube reactors in combination with a twin screw extruder are named as reactors.

If, however, aromatic chain extenders are used in combination with the usual TPU catalysts, such as, for example Ti— catalysts, in the procedure disclosed in U.S. Pat. No. 5,795,948, the result is a non-homogenous product with inferior properties. In addition, there may be problems with a customary melt filtration.

U.S. Pat. No. 6,022,939 disclosed the preparation of TPU by reacting diisocyanate with polyether and a chain extender mixture containing substituted benzene and alkanediols in the presence of dibutyltin dilaurate as a catalyst. The products are manufactured batch wise with a contact time greater than 1 hour. Under the manufacturing conditions for continuous production however, and because of the lowered crystallinity, which is interfered with by the second chain extender, the result is non-homogenous, sticky products that are difficult to remove.

The object of the present invention was to provide a continuous and economical process for the production of thermoplastically processable polyurethane elastomers having high thermal stability and very high elasticity. The objective was achieved through the use of special combination of reaction components and reaction parameters.

The invention is directed to a continuous process, carried out at a temperature of 130 to 250° C., for the preparation of thermoplastically processable polyurethane elastomers (TPU's) having glass temperature (T_{g}) below 50° C. comprising reacting:

A) at least one polyether diol having, on average, 1.8 to 2.2 Zerewitinoff active hydrogen atoms and a number average molecular weight (Mₙ) of 450 to 10,000,

B) at least one organic diisocyanate and

C) 1,4-di-(2,2′-hydroxyethyl)-hydroquinone in the presence of 10 to 1,000 ppm based on polyether (A) of stannous (tin) dioctoate as catalyst, and with the proviso that the NCO/OH ratio of A), B) and C) is 0.85 to 1.2.

The TPU thus produced may optionally contain auxiliary or accessory agents that are incorporated for their art-recognized function. Aliphatic, cycloaliphatic, araliphatic, aromatic and heterocyclic diisocyanates or any mixture of these diisocyanates may be used as organic diisocyanates (B) (Suitable diisocyanates are disclosed in HOUBEN-WEYL “The Methods of Organic Chemistry”, Volume E2-“Macromolecular Substances”, Georg Thieme Publishing House, Stuttgart, N.Y. 1987, Pages 1587-1593 and Justus Liebigs Anomalies of Chemistry, 562 pages, pages 75 to 136, both documents incorporated by reference herein).

Examples include aliphatic diisocyanates such as ethylene diisocyanate, 1,4-tetramethylene diisocyanate, 1,6-hexamethylene diisocyanate, 1,12-dodecandiisocyanate; cycloaliphatic diisocyanates such as isophoron diisocyanate, 1,4-cyclohexane diisocyanate, 1-methyl-2,4-cyclohexane diisocyanate and 1-methyl-2,6-cyclo hexane diisocyanate as well as the corresponding isomeric mixtures, 4,4′dicyclohexylmethane diisocyanate, 2,4′-dicyclohexylmethane diisocyanate and 2,2′-dicyclohexylmethane diisocyanate as well as the corresponding isomeric mixtures; additionally suitable are aromatic diisocyanates such as 2,4-toluylene diisocyanate, mixtures out of 2,4 toluylene diisocyanate and 2,6 toluylene diisocyanate, 4,4′-diphenyl methane diisocyanate, 2,4′-diphenyl methane diisocyanate and 2,2′-diphenylmethane diisocyanate, urethane modified liquid 4,4′-diphenyl methane diisocyanates or 2,4′-diphenyl methane diisocyanate, 4,4′-diisocyanato diphenylethane-(1,2) and 1,5-naphthalene diisocyanate. Preferred isocyanates are 1,6-hexamethylene diisocyanate, 1,4-cyclohexane diisocyanate, isophorone diisocyanate, dicyclohexylmethane diisocyanate, diphenyl-methane diisocyanate-isomeric mixture with a 4,4′-diphenyl-methane diisocyanate content of more than 96 percentage weight and in particular 4,4′-diphenyl methane diisocyanate and 1,5-naphthylene diisocyanate. The named diisocyanates may be used either individually or in the form of mixtures with one another. They may also be used together with up to 15 mol-% (calculated with reference to the total diisocyanate) of a polyisocyanate, but at most only so much polyisocyanate may be added so that the resulting product is still thermoplastically processable. Examples of polyisocyanates are triphenylmethane-4,4′,4″-triisocyanate and polyphenyl-polymethylene polyisocyanates.

Reactant (A) includes at least one polyether diol having, on average, 1.8 to 2.2 Zerewitinoff active hydrogen atoms and a number average molecular weight (Mₙ) of 450 to 10,000.

Suitable polyether diols may be manufactured by reacting one or several alkylene oxides with 2 to 4 carbon atoms in the alkylene residue with a starter molecule, which contains two active hydrogen atoms. Alkylene oxides, which may be mentioned are, for example: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably used. The alkylene oxides may be used separately or in mixtures one with the others. Examples of starter molecules include water, amino alcohols such as N-alkyldiethanol-amine, for instance N-methyl-diethanol-amine and diols like ethylene glycol, 1,3-propylene glycol, 1,4-butane diol and 1,6-hexane diol. Optionally, mixtures of starter molecules may also be used.

Other suitable polyether diols, are the polymerization products of tetrahydrofuran containing hydroxyl groups. Trifunctional polyether triols in quantities of 0 to 30 percentage weight based on the bifunctional polyether diols may also be used, however at most in a quantity being such that the resulting product is still thermoplastically processable. Preferred are substantially linear polyether diols having on average 1.8-2.2 Zerewitinoff active hydrogen atoms and a number average molecular weight (Mₙ) of 450 to 6,000. These may be used in the application both separately and in the form of mixtures with one another or in a mix with polyester diols. Polyester diols in place of polyether diols are also an option.

Monofunctional compounds may be used as so-called chain stoppers in amounts of up to 2 percent by weight in relation to the TPU. For example, those appropriate are monoamines like butyl and dibutyl amine, octyl amine, stearylamine, N-methylstearylamine, pyrrolidine, piperidine or cyclohexylamine, mono alcohols like butanol, 2-ethylhexanol, octanol, dodecanol, stearylalcohol the various amyl alcohols, cyclohexanol and ethylene glycol methyl ether.

The relative quantities of the compounds (A) and (C) are selected in such a way that the ratio of the total of the isocyanate groups in (B) to the total of the isocyanate reactive hydrogen atoms in (A) and (C) amounts to 0.85:1 to 1.2:1, more preferably 0.95:1 to 1.1:1.

Tin dioctoate is used as a catalyst in an amount of 10 to 1,000 ppm, preferably from 50 to 300 ppm, in relation to polyether (A).

The thermoplastic polyurethane elastomers in accordance with this invention may contain auxiliary substances or accessory agents that are known for their function in TPU in amounts of up to 20 percent, in relation to the total weight of TPU. Typical auxiliary substances or accessory agents are dyes, pigments, flame proofing agents, reinforcing agents, stabilizers against the influences of aging and the elements (for example, against hydrolysis, light, heat and discoloration), softeners, anti-blocking agents, inhibitors, lubricants and mold-release agents, substances with fungicidal and bacteriostatic effects as well as inorganic and/or organic fillers and their mixtures.

Examples of lubricating agents are fatty esters, the metallic soaps thereof, fatty acid amides, fatty ester amides and silicone compounds. Reinforcing agents are in particular fibrous reinforcing materials such as for example, inorganic fibers, optionally treated with a lubricating release agent. More detailed information regarding the above mentioned optional auxiliary substances and accessory agents can be gathered from the technical literature, for example, the incorporated by reference monographs by J. H. Saunders and K. C. Frisch, entitled “High Polymers”, Volume XVI, Polyurethanes Parts 1 and 2, Interscience Publishers publishing house 1962 and 1964 respectively, in the Pocket Book for Plastic-Additives by R. Gaechter and H. Mueller (Hanser publishing house, Munich 1990) and in DE A 29 01 774.

Other additives, which that may be incorporated into the TPU are thermoplastics, for example, polycarbonates and acrylonitrile-butadiene-styrene-terpolymers, in particular ABS. Other elastomers such as rubber, ethylene/vinyl acetate copolymers, and styrene/butadiene copolymers as well as other TPU's may likewise be used.

The continuous production procedure in accordance with the invention is carried out at temperatures of 130 to 250° C. In this, prior to the start of the reaction, the raw material poly ether A) and diol C) are heated to 130 to 230° C. and the organic diisocyanate to 50 to 150° C. At the end of the reaction, because of the exothermic reaction, 180 to 250° C. is achieved.

The TPU in accordance with the invention may be manufactured following the conventional mixing head/belt procedure or the so-called extruder procedure. In extruder procedures, for example, in a multiple shaft extruder, feeding of components A), B), and C) may be simultaneous, that is to say, in a one-shot procedure or one after the other, that is to say, following a prepolymer procedure. In this way the prepolymer can be manufactured both batch-wise and continuously. In continuous prepolymer process the prepolymer is manufactured in the first part of the extruder or in a separate preceded prepolymer aggregate that is connected in series. Such a prepolymer aggregate may be a stirred tube reactor or one or several sequential static mixers.

The TPU manufactured following the continuous prepolymer procedure is preferred, especially preferred is the prepolymer procedure that is carried out in an extruder.

The total reaction time from the start of the reaction to its completion and attainment of a TPU melt amounts to 0.3 to 3 minutes, preferably 0.5 to 2 minutes.

The prepared TPU melts are preferably filtered at the exit-end of the extruder using a filtration screen with a mesh size of 30 to 300 μm.

The TPU in accordance with the invention may be further processed, for example, by tempering of the polymer in the form of slabs or blocks, comminution or granulation in shredders or mills, degassing as well as granulation while being melted. Preferably the polymer is guided through an aggregate for continuous degassing and strand formation. For this aggregate this may be a multiple shaft extruder that is fitted with only a few kneaders, optionally with none at all.

The continuous manufacturing procedure in accordance with the invention at high temperatures and with a short residence time enables the production of this class of TPU with its particular profile of characteristics.

The TPU's manufactured following the procedure in accordance with the invention are very homogenous, have very good mechanical and elastic properties and distinguish themselves by their high thermal stability. The TPU's manufactured in accordance with the invention may be used in injection molding of articles and in extrusion. The injection sheets manufactured in this way are homogenous and have very good mechanical properties.

The invention is further illustrated but is not intended to be limited by the following examples in which all parts and percentages are by weight unless otherwise specified.

### FORMULATION 1 (EXAMPLES 1, 3 TO 5)

62.1 parts by weight (pbw) of a polybutylene oxide (number average molecular weight approximately 1000) were heated with 0.1 pbw of pentaerythryltetrakis(3(3,5-to-1,1-dimethylethyl)-4-hydroxyl phenyl)propionate and the corresponding catalyst (see the table) to the respective starting temperature to produce a mixture. The mixture was continuously fed into three in-line, static mixers connected in series (Sulzer DN 50). At the same time 28.4 pbw of 4,4′-diphenyl methane diisocyanate (60° C.) was pumped into the static mixer.

The resulting prepolymer was fed into the first feed port of an extruder (Werner & Pfleiderer; ZSK 120) and 9.4 pbw 1,4-di-(2,2′-hydroxyethyl)-hydroquinone were continuously added through feeding port 3. The rotational speed of the screw was 240 revolutions/min.

At the discharge end of the extruder the melt was filtered with an inserted metal screen with a mesh size of 200 μm, extracted as strands, cooled in a water bath and granulated.

### FORMULATION 2 (EXAMPLE 2)

The separate feeding streams into the extruder (ZSK 120) were:

A) Mixture (A) through feed port 1 of the extruder:

| | |
|---|---|
| 61.9 pbw | Polybutylene oxide (number average molecular weight |
| | approx. 1000) |
| 0.1 pbw | pentaerythryltetrakis (3(3,5-to-1,1-dimethyl ethyl)-4- |
| | hydroxyl phenyl)propionate |
| 0.2 pbw | hexane diol |
| | Catalyst (see table) |

B) into feed port 1 of the extruder

| | |
|---|---|
| 9.4 pbw | 1,4-di-(2,2′-hydroxyethyl) hydroquinone |

C) into feed port 3 of the extruder

| | |
|---|---|
| 28.4 pbw | 4,4′-diphenyl methane diisocyanate. |

### FORMULATION 3 (EXAMPLES 6 AND 7)

The procedure used in connection with formulation 1 was followed, using the following raw materials were fed in:

| | |
|---|---|
| 42.1 pbw | of a polybutylene oxide (number average molecular weight |
| | approximately 1000), |
| 0.1 pbw | pentaerythryltetrakis(2(3,5-to 1,1-dimethyl ethyl)-4-hydroxyl |
| | phenyl)-propionate, |
| | Catalyst (see table) |
| 37.5 pbw | 4,4′-diphenyl methane diisocyanate, |
| 20.3 pbw | 1,4-di-(2,2′-hydroxyethyl)-hydroquinone. |

The test specimens were manufactured from the pellets in an injection molding machine (screw diameter 28 cm—Kloeckner). Hardness was determined in accordance with DIN 53505, the tensile properties were determined in accordance with DIN 53504.

A summary of the results is presented in the following tables. Homogeneity of the product and a clearly extended tool life of the screen are clear advantages in the application of the procedure in accordance with the invention. Referring to the tables: TAC denotes titanium acetyl acetonate and SND denotes tin dioctoate

In the embodiment relating to the continuous production of TPU, the non-homogeneities are filtered off, for example, through a melt-screen (for example, at the exit-end of the extruder). The pressure in front of the melt-screen increases over time. As soon as the maximum permissible pressure is reached the screen needs to be replaced. (The time elapsing before the change indicates the screen tool life). Through the procedure in accordance with the invention considerably fewer non-homogeneities are formed so that the tool lives of the screens are considerably longer than those in the implementation of known procedures.

The products manufactured in the procedure in accordance with the invention are very homogeneous and display improved mechanical values (ultimate tensile strength/stretch) as compared with products that are manufactured using known procedures.

Table 1 is a summary of the conditions used in the preparation of the TPU, including TPU's of the invention (Examples 3,4,5 and 7) and such that are not within the scope of the invention (1,2 and 6)

TABLE 1

| | | | Start | ZSK | Screen | Quality of the |
|---|---|---|---|---|---|---|
| | | Catalyst/amount | Temperature | Temperature | Tool Life | Injection molded |
| Example | Formulation | (ppm) | Polyol (° C.) | (° C.) | (hours) | test specimens |
| 1* | 1 | TAC/10 | 180 | 180-220 | 0.3 | HNH |
| 2* | 2 | TAC/10 | 195 | 180 | 0.3 | NH |
| 3 | 1 | SND/110 | 215 | 200-240 | 2 | H |
| 4 | 1 | SND/110 | 154 | 180-210 | 2 | H |
| 5 | 1 | SND/110 | 138 | 150-200 | 4 | H |
| 6* | 3 | TAC/10 | 180 | 160-180 | 0.3 | NH |
| 7 | 3 | SND/110 | 160 | 160-180 | 2 | H |

HNH—denotes highly non homogeneous, H denotes homogeneous and NH means non homogeneous.
*Comparative examples not in accordance with the invention
TAG—titanylacetylacetonate
SND—tindioctoate

Table 2 is a summary of the properties of the products.

TABLE 2

| | Glass | | | | | Elon- |
|---|---|---|---|---|---|---|
| | transition | Shore | Pull rate | 100%- | Tensile | gation |
| Exam- | temperature | Hard- | Tensile Test | Module | Strength | Break |
| ple | *(° C.) | ness | [mm/min] | [MPa] | [MPa] | [%] |
| 1* | −46 | 84 A | 50 | 6.4 | 38 | 400 |
| 2* | −45 | 87 A | 50 | 6.9 | 34 | 400 |
| 3 | −46 | 87 A | 50 | 6.8 | 47 | 438 |
| 4 | −46 | 88 A | 50 | 6.8 | 51 | 458 |
| 5 | −46 | 86 A | 50 | 6.6 | 51 | 480 |
| 6* | −19 | 63 D | 500 | 23 | 36 | 347 |
| 7 | −19 | 60 D | 500 | 27 | 39 | 393 |

*Glass transition temperature TG from dynamic mechanical analysis (DMA)

Although the invention has been described in detail in the foregoing for the purpose of illustration, it is to be understood that such detail is solely for that purpose and that variation can be made therein by those skilled in the art without departing from the spirit and scope of the invention except as it may be limited by the claims.

What is claimed is:

1. A continuous process for the preparation of a thermoplastic polyurethane elastomer at a temperature of 130 to 250° C. comprising reacting:
A) at least one polyether diol having a number average molecular weight (Mₙ) of 450 to 10,000 and, on average, 1.8 to 2.2 Zerewitinoff active hydrogen atoms; with
B) at least one organic diisocyanate; and
C) 1,4-di-(2,2′-hydroxyethyl)-hydroquinone, in the presence of 10 to 1000 ppm in relation to A) of tin dioctoate as a catalyst
with the proviso that the NCO/OH ratio of the reactants A), B) and C) is 0.85 to 1.2, said thermoplastic polyurethane having a glass transition temperature (T_{g}) below 50° C.

2. The process of claim 1 wherein the preparation takes place in an extruder.

3. The process of claim 1 wherein the preparation is carried out in a prepolymer process.

4. The process of claim 2 wherein the preparation is carried out in a prepolymer process.

5. The polyurethane elastomer prepared in accordance with the process of claim 1.

6. The polyurethane elastomer of claim 5 further containing at least one member selected from the group consisting of auxiliary substances and accessory agents.
